(19) United States
(12) Patent Application Publication
(10) Pub. No.: US 2025/0113217 A1
(43) Pub. Date: Apr. 3, 2025

(54) WLAN SENSING MEASUREMENT REPORTS

(71) Applicant: INTERDIGITAL PATENT HOLDING, INC., Wilmington, DE (US)

(72) Inventors: Mahmoud Saad, Montreal (CA); Zinan Lin, Basking Ridge, NJ (US); Hanqing Lou, Syosset, NY (US); Rui Yang, Greenlawn, NY (US); Satyanarayana Katla, London (GB)

(73) Assignee: INTERDIGITAL PATENT HOLDING, INC., Wilming, DE (US)

(21) Appl. No.: 18/833,210

(22) PCT Filed: Jan. 25, 2023
(86) PCT No.: PCT/US2023/011512

§ 371 Date: Jul. 25, 2024

Related U.S. Application Data
(60) Provisional application No. 63/303,349, filed on Jan. 26, 2022.
(60) Provisional application No. 63/313,513, filed on Feb. 24, 2022.
(60) Provisional application No. 63/337,761, filed on May 3, 2022.

(51) Int. Cl. H04W 24/02; H04B 7/06; H04W 24/10

(52) U.S. Cl. CPC H04W 24/02; H04B 7/0626; H04W 24/10

(57) ABSTRACT

A sensing receiver may be configured for wireless local area network (WLAN) sensing, The sensing receiver may be configured to receive, from a sensing transmitter, a packet, perform measurements on the received packet, and prepare a sensing measurement report, which may comprise at least a measurement report control field and a measurement report field. A measurement type dependent parameters subfield of the measurement report control field may be based on a measurement type. The sensing receiver may be configured to send, to the sensing transmitter, the sensing measurement report. Contents of the measurement report field may be based on the measurement type. The measurement type may comprise at least one of: a channel state information (CSI) type, a channel impulse response (CIR) type, or a directional multi-gigabit (DMG)/enhanced DMG (EDM) type. The packet may be a null data packet (NDP) or a physical layer protocol data unit (PPDU).

### CROSS-REFERENCE TO RELATED APPLICATIONS

This application claims the benefit of U.S. Provisional Application No. 63/303,349, filed Jan. 26, 2022; U.S. Provisional Application No. 63/313,513, filed Feb. 24, 2022; U.S. Provisional Application No. 63/337,761, filed May 3, 2022, the contents of which are incorporated herein by reference.

### BACKGROUND

A wireless local area network (WLAN) in Infrastructure Basic Service Set (BSS) mode has an Access Point (AP) for the BSS and one or more stations (STAs) associated with the AP. The AP typically has access or interface to a Distribution System (DS) or another type of wired/wireless network that carries traffic in and out of the BSS. Traffic to STAs that originates from outside the BSS arrives through the AP and is delivered to the STAs. Traffic originating from STAs to destinations outside the BSS is sent to the AP to be delivered to the respective destinations. Traffic between STAs within the BSS may also be sent through the AP where a source STA sends traffic to the AP and the AP delivers the traffic to a destination STA.

### SUMMARY

A sensing receiver may be configured for wireless local area network (WLAN) sensing, The sensing receiver may be configured to receive, from a sensing transmitter, a packet. The sensing receiver may be configured to perform measurements on the received packet. The sensing receiver may be configured to prepare a sensing measurement report. The sensing measurement report may comprise at least a measurement report control field and a measurement report field. A measurement type dependent parameters subfield of the measurement report control field may be based on a measurement type The sensing receiver may be configured to send, to the sensing transmitter, the sensing measurement report. The received packet may comprise training symbols. The packet may be a null data packet (NDP) or a physical layer protocol data unit (PPDU). The measurement report control field may comprise information for interpretation of sensing measurements included in the measurement report control field. The measurement type may comprise at least one of: a channel state information (CSI) type, a channel impulse response (CIR) type, or a directional multi-gigabit (DMG)/enhanced DMG (EDMG) type. The measurement type dependent parameters subfield for the CSI type may comprise at least: a coefficient size (Nb) parameter, a subcarrier grouping (Ng) parameter, and a measurement instance identification (MII) parameter. The measurement type dependent parameters subfield for a CIR type may comprise at least: a coefficient size parameter and a number of values parameter. The measurement type dependent parameters subfield for a DMG/EDMG type may comprises at least: a number of dimensions of a filtered MAP parameter and a coefficient size parameter. Parameters of the measurement type dependent parameters subfield may be used to parse the sensing measurement report. The measurement report control field may comprise an aggregate report indication to indicate whether the sensing measurement report comprises one sensing measurement result or multiple aggregated sensing measurement results.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example of a trigger frame format;

FIG. 3 is an example of an EHT Variant User Info field format;

FIG. 4 is an example of an EHT Special User Info field format;

FIG. 5 shows example of an EHT operation information element;

FIG. 6 shows an example of EHT operation information subfields;

FIG. 7 is an example of a Measurement Report Control field;

FIG. 8 shows an example of Measurement Type Dependent Parameters of a Measurement Report Control Field for a frequency domain measurement result;

FIG. 9 shows an example of Measurement Type Dependent Parameters of a Measurement Report Control Field for a time domain measurement result;

FIG. 10 shows an example of Measurement Type Dependent Parameters of a Measurement Report Control Field for a DMG/EDMG measurement result;

FIG. 11 shows an example design of a Measurement Report field for CSI and Partial-CSI measurement type;

FIG. 12 shows an example design of a Measurement Report field for CIR measurement type;

FIG. 13 shows an example design of a Measurement Report field for CIR measurement type;

FIG. 14 shows an example method of WLAN sensing for a sensing receiver;

FIG. 15 shows an example method of WLAN sensing for a sensing transmitter;

FIG. 16 is an example method of multiple sensing reports where each report is carried in a separate PPDU;

FIG. 17 is an example of multiple sensing reports where multiple reports are aggregated in one PPDU;

FIG. 18 is an example of an enhanced EHT variant Common Info field format;

FIG. 19 shows an example encoding of a TXOP Sharing Mode subfield;

FIG. 20 is an example of an Enhanced MU-TRS TXS Trigger frame with a TXOP Sharing Mode subfield value equal to 1 and soliciting sensing measurement reports from the AP to the scheduled STA;

FIG. 21 is an example of an Enhanced MU-TRS TXS Trigger frame with a TXOP Sharing Mode subfield value equal to 2 are soliciting sensing measurement reports from another STA;

FIG. 22 is an example of an Enhanced MU-TRS TXS Trigger frame with a TXOP Sharing Mode subfield value equal to 3 and soliciting sensing measurement reports are from the AP;

FIG. 23 is an example of non-uniform quantization;

FIG. 24 is an example of a signaling procedure between a sensing transmitter (Tx) and a sensing receiver (Rx);

FIG. 25 shows an example procedure of multi-antenna sensing in a TB sensing measurement instance; and

FIG. 26 shows an example procedure of multi-antenna sensing in a non-TB sensing measurement instance.

### DETAILED DESCRIPTION

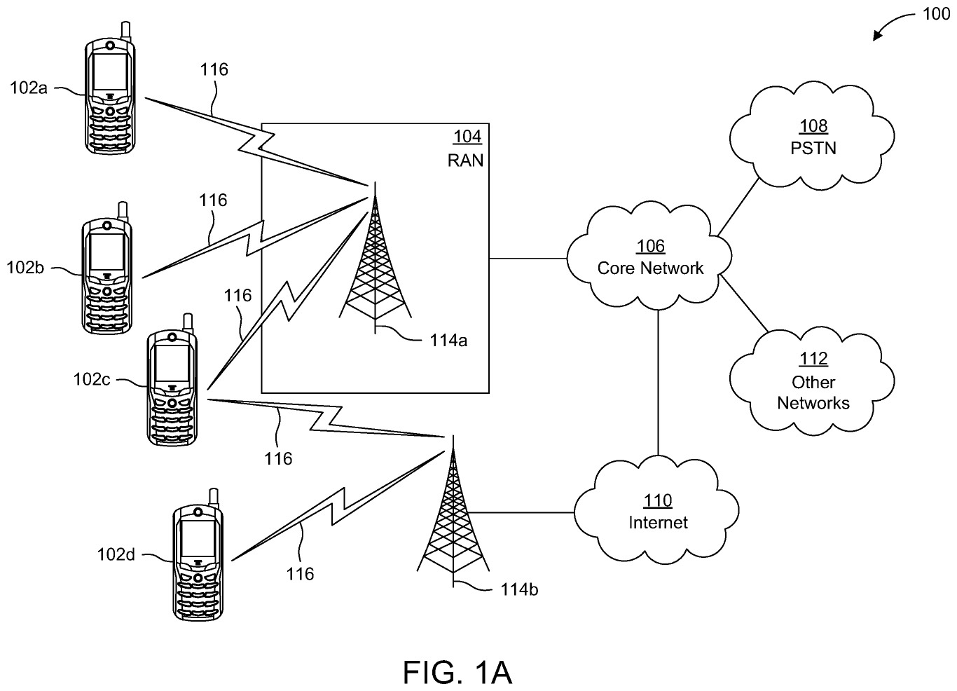

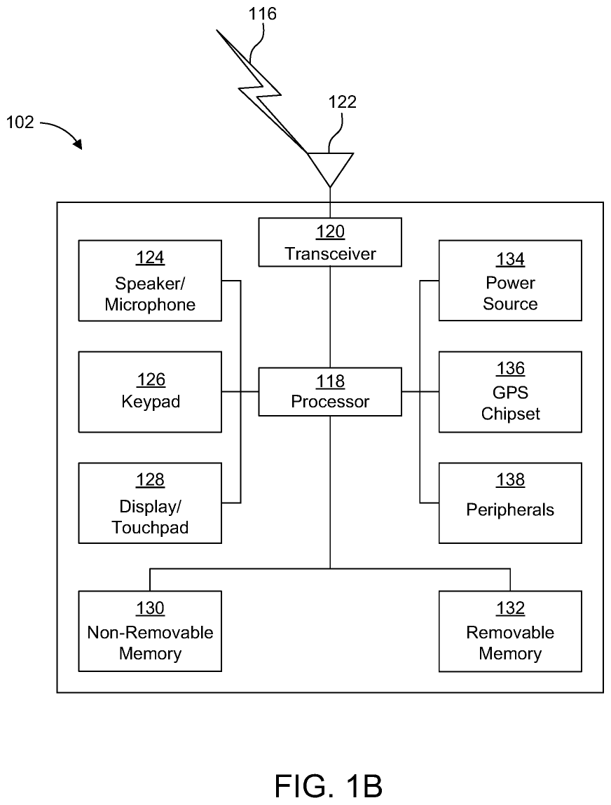

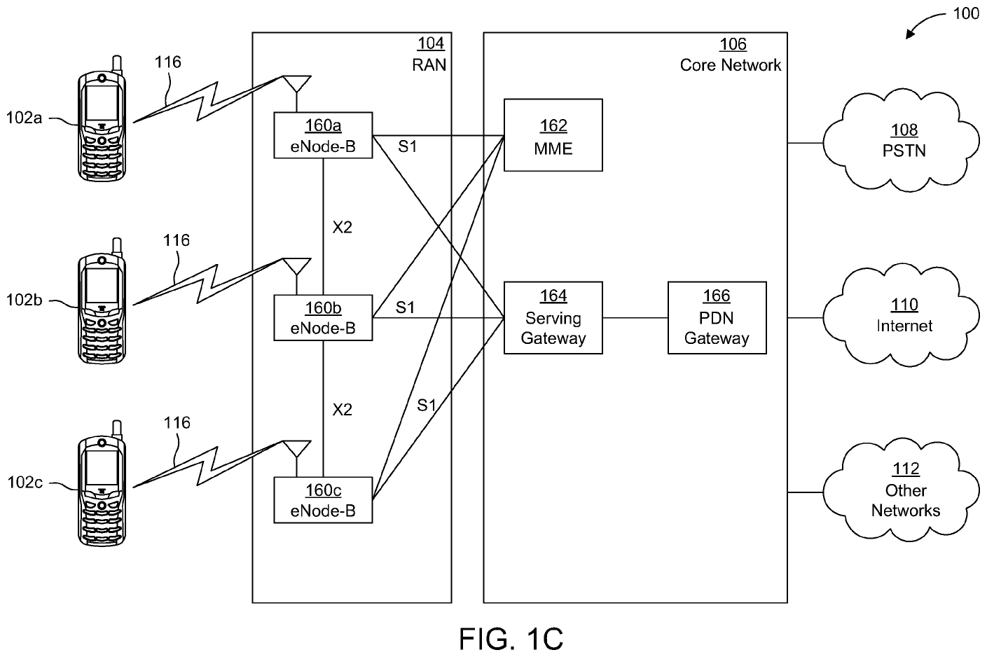

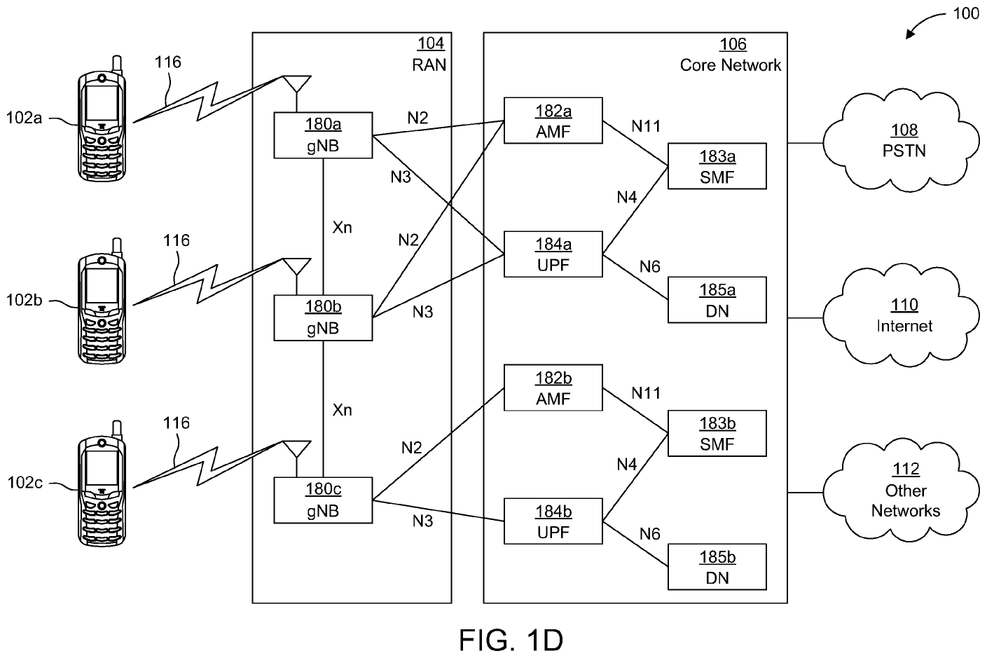

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Using an 802.11ac infrastructure mode of operation, an AP may transmit a beacon on a fixed channel, such as a primary channel. This channel may be, for example, 20 MHz wide, and may be the operating channel of the BSS. This channel may also be used by the STAs to establish a connection with the AP. A channel access mechanism in an 802.11 system may be a Carrier Sense Multiple Access with Collision Avoidance (CSMA/CA). In this mode of operation, every STA, including the AP, may sense the primary channel. If the channel is detected to be busy, the may STA back off. Hence, only one STA may transmit at any given time in a given BSS.

In 802.11n, High Throughput (HT) STAs may use a 40 MHz wide channel for communication. This may be achieved by combining a primary 20 MHz channel with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz and 80 MHz channels may be formed by combining contiguous 20 MHz channels similar to 802.11n. A 160 MHz channel may be formed by combining eight contiguous 20 MHZ channels or by combining two non-contiguous 80 MHz channels, which may also be referred to as an 80+80 configuration. For the 80+80 configuration, the data, after channel encoding, may be passed through a segment parser that may divide it into two streams. An inverse Discrete Fourier Transformation (IDFT) operation and time-domain processing may be done on each stream separately. The streams may then be mapped to the two channels, and the data may be transmitted. At the receiver, this procedure may be reversed and the combined data may be sent to the MAC.

To improve spectral efficiency, 802.11ac introduced the concept for downlink Multi-User MIMO (MU-MIMO) transmission to multiple STAs in the same symbol's time frame, for example, during a downlink OFDM symbol. The potential for the use of downlink MU-MIMO is considered for 802.11ah. Since downlink MU-MIMO, as it is used in 802.11ac, uses the same symbol timing to multiple STAs, interference of a waveform transmissions to multiple STAs is not an issue. However, all STAs involved in MU-MIMO transmission with the AP use the same channel or band and this may limit the operating bandwidth to the smallest channel bandwidth that is supported by the STAs which are included in the MU-MIMO transmission with the AP.

An IEEE 802.11 Extremely High Throughput (EHT) Study Group was formed in September 2018. EHT is considered the next major revision to IEEE 802.11 standards following 802.11ax. EHT is formed to explore the possibility to further increase peak throughput and improve efficiency of the IEEE 802.11 networks. Following the EHT Study Group, the 802.11be Task Group was established to provide for 802.11 EHT specifications. The primary use cases and applications addressed include high throughput and low latency applications such as video-over-WLAN, augmented reality (AR), and virtual reality (VR).

A list of features that have been discussed in the EHT study group and 802.11be to achieve a target of increased peak throughput and improved efficiency include: multi-AP coordination, multi-band/multi-link, 320 MHz bandwidth, 16 spatial streams, HARQ, and new designs for 6 GHz channel access.

An IEEE 802.11bf standard will be a new amendment to IEEE 802.11 for wireless sensing capability in WLAN. A new task group, TGbf, has been formed to generate the specification documents, which may include the following. A sensing procedure may allow a STA to perform WLAN sensing and obtain measurement results. A sensing session may be an instance of a sensing procedure with associated operational parameters of that instance. A sensing initiator may be a STA that initiates a WLAN sensing session. A sensing responder may be a STA that participates in a WLAN sensing session initiated by a sensing initiator. A sensing transmitter may be a STA that transmits a physical layer protocol data unit (PPDU) that may be used for sensing measurements in a sensing session. A sensing receiver may be a STA that receives a PPDU sent by a sensing transmitter and may perform sensing measurements in a sensing session. A STA may assume multiple roles in one sensing session. In a sensing session, a sensing initiator may be a sensing transmitter, a sensing receiver, both, or neither.

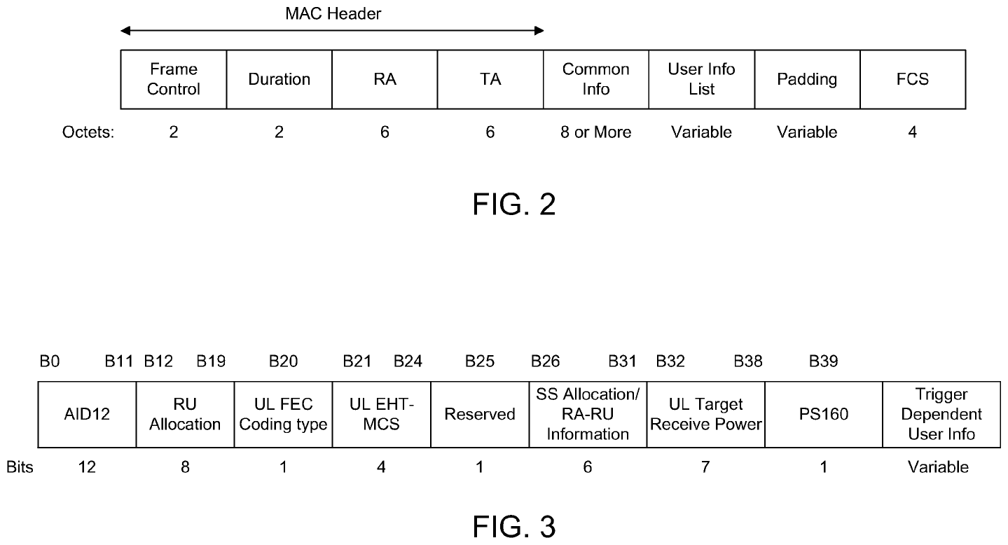

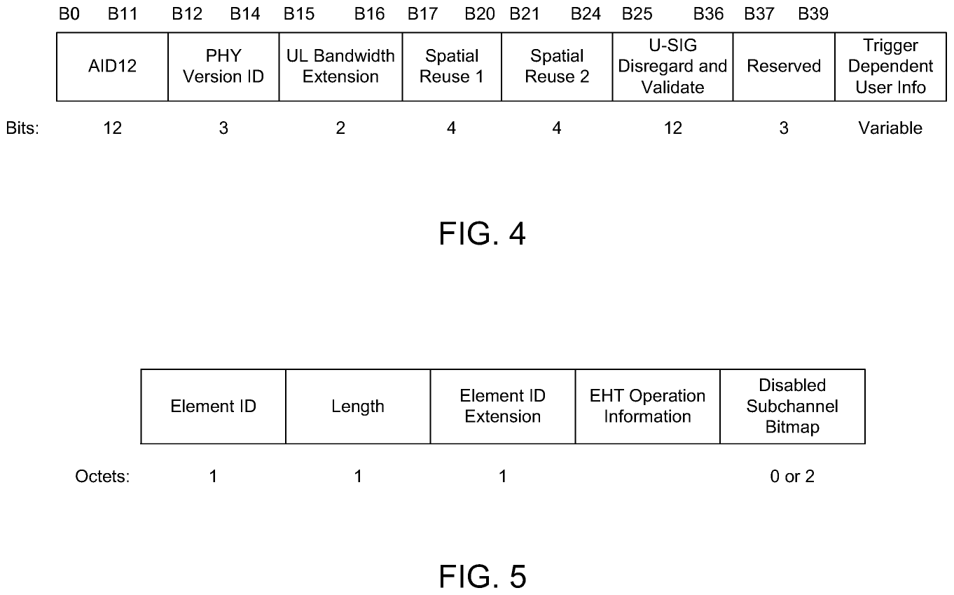

A trigger frame was introduced in 802.11ax to allocate resources and trigger single or multi-user access in the uplink. An example trigger frame format is shown in FIG. 2. In 802.11be, a new variant of a User Info field is proposed, as shown in FIG. 3, and a Special User Info field is added after the Common Info field, as shown in FIG. 4. These enhancements allow a unified triggering scheme for both HE and EHT devices.

Preamble puncturing was introduced in 802.11ax to allow a STA to transmit on certain subchannels but not the entire bandwidth. The preamble puncturing transmission of a PPDU may have no signal present in one or more subchannels within the PPDU bandwidth. In 802.11be, there are two types of preamble puncturing schemes: static puncturing and dynamic puncturing.

With static puncturing, one or more subchannels may be punctured for one or more beacon intervals. An AP may add a disabled subchannel bitmap field in an EHT operation information element to indicate one or more subchannels are disabled. STAs may set a TXVECTOR parameter INACTIVE_SUBCHANNELS of an HE, EHT, or non-HT duplicate PPDU based on a value indicated in the most recently exchanged disabled subchannel bitmap field in the EHT operation element for that BSS. STAs may not transmit anything on the disabled subchannels.

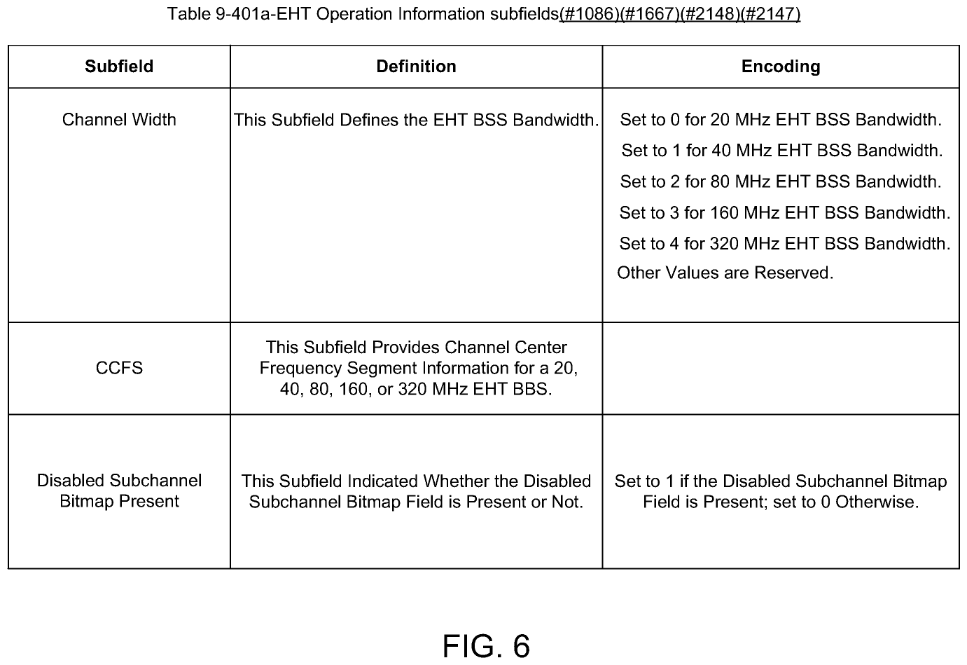

An example of an EHT operation information element is shown in FIG. 5. The EHT operation information element may comprise an element identification (ID) field, a length field, an element ID extension field, and EHT operation information field, and a disabled subchannel bitmap field. An example of subfields of an EHT operation information field are shown in FIG. 6. The subfields of the EHT operation information element may comprise a channel width subfield, a CCFS subfield, and a disabled subchannel bitmap present subfield. A disabled subchannel bitmap may be two octets long if present.

With dynamic puncturing, a STA may be allowed to puncture additional subchannels other than the ones indicated by a disabled subchannel bitmap field. The STA may determine to puncture additional subchannels for different reasons, for example, based on physical or virtual channel sensing results. Dynamic puncturing may be explicitly signaled using, for example, a U-SIG field in an EHT MU PPDU. A punctured channel information field may be carried in the U-SIG field in the EHT MU PPDU to indicate the punctured channels.

Preamble puncturing in WLAN sensing measurement instances, both trigger based and non-trigger based, are not currently supported. To support preamble puncturing in WLAN sensing, indications and signals are needed in NDPA, NDP, and Trigger frame variants. Also, the support of preamble puncturing considering STAs belonging to different generations requires a backward compatible design. Furthermore, the behavior of the STAs participating in the sensing sessions needs to be defined.

In a sensing session, a sensing receiver may measure a null data packet (NDP) or any other PPDU with training symbols for sensing measurements and may prepare the sensing results. The sensing results may be different for different measurement types (e.g., channel state information (CSI), partial CSI, differential CSI, channel impulse response (CIR), etc.) and may be reported using, for example, a Sensing Measurement Report frame. Such a frame may comprise at least two fields: a Measurement Report Control field and a Measurement Report field. The Measurement Report Control field may comprise information for the interpretation of the sensing measurements carried by the Measurement Report field. A proper design of the Sensing Measurement Report frame that comprises different possibilities in WLAN sensing is needed.

Given a limited capability, some devices that receive a CSI feedback request may not be able to send the measurement report immediately after the reception of a NDP. Therefore, there is a need to design a procedure to enable a delayed sensing report.

The CSI/compressed CSI values obtained at a sensing receiver may have to be quantized to bits to send CSI feedback to a sensing transmitter. The CSI/compressed CSI may be quantized using a uniform quantization function. However, this is not always appropriate for sensing applications where small amplitude variations appear more frequent than large amplitude variations and vice versa. In this scenario, using a non-uniform quantization function may help in minimizing the quantization loss and reduce the loss of sensing information.

In some sensing applications, multiple antennas may be used for sensing. Different sensing applications may have different accuracy requirements on the sensing measurement results. There is a need for procedures on how a STA may use multiple antennas for sensing and a need to define the protocols to enable multiple antennas sensing for different applications given a STA's capabilities.

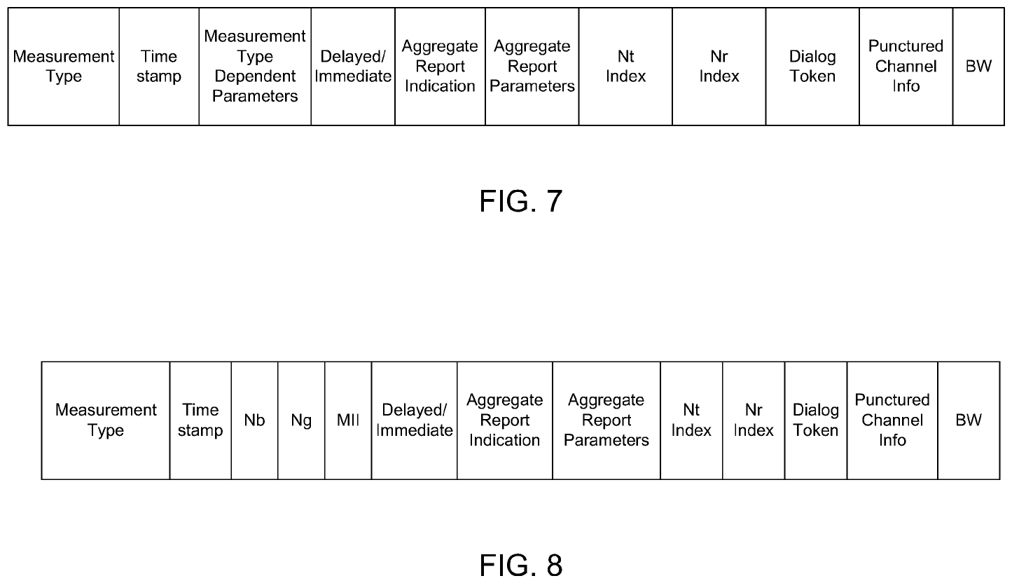

An example Measurement Report Control field of a Sensing Measurement Report frame is shown in FIG. 7. A Measurement Report Control field of a Sensing Measurement Report may comprise a measurement type subfield. The measurement type subfield may indicate a type of the sensing measurement. The type of the sensing measurement may be from a set of measurement types (i.e. a measurement type set). The measurement type set may comprise frequency domain measurement types such as channel state information (CSI), Partial CSI (e.g., only amplitude information or phase information), or Differential CSI where a reference CSI may be sent and in subsequent transmissions a difference between a current measurement and reference measurement may be sent. The measurement type set may comprise time-domain measurement types such as CSI represented in time-domain, Channel Impulse Response (CIR), punctured CIR (PCIR) (e.g., only a subset of the CIR is sent), Power Delay Profile (PDP), Differential CIR, Differential PCIR, or Differential PDP. The measurement type set may comprise Directional Multi-Gigabit (DMG)/enhanced DMG (EDMG) measurement types. The measurement type for DMG/EDMG may comprise a multi-dimensional (e.g., 2D, 3D, or 4D) map of range, azimuth, elevation, and/or doppler, and it may comprise reporting detected objects from a defined set of objects or a general object.

The Measurement Report Control field of the Sensing Measurement Report may comprise a Timestamp subfield. The Timestamp subfield may indicate a time at which the measurement result is computed or a time at which a NDP PPDU or any other PPDU with training symbols for sensing measurements is received.

The Measurement Report Control field of the Sensing Measurement Report may comprise a Measurement Type Dependent Parameters subfield. The Measurement Type Dependent Parameters subfield may carry signaling information that may be different for different measurement types.

The Measurement Report Control field of the Sensing Measurement Report may comprise a Delayed/Immediate subfield. The Delayed/Immediate subfield may indicate if a measurement is an immediate measurement or a delayed measurement. Delayed measurements may be used to facilitate the aggregation of multiple sensing measurement results in one Measurement Report.

The Measurement Report Control field of the Sensing Measurement Report may comprise an Aggregate Report Indication subfield. The Aggregate Report Indication subfield may indicate if the Measurement Report comprises one sensing measurement result or multiple aggregated sensing measurement results.

The Measurement Report Control field of the Sensing Measurement Report may comprise an Aggregate Report Parameters subfield. The Aggregate Report Parameters subfield may be used to provide parameters to interpret aggregated measurement results in case of an aggregated report (e.g. the Aggregated Report Indication is set to true or set to anything that indicates an aggregated report). This may comprise a Number of Aggregated Reports parameter to indicate how many reports are aggregated together in the Measurement Report and may also comprise a Measurement identification (ID) to indicate what measurement instance is included in the report.

The Measurement Report Control field of the Sensing Measurement Report may comprise a number of transmit antennas (Nt) Index subfield. The Nt Index subfield may indicate a number of antennas, or an index referring to a number of antennas, which may be used to transmit a NDP PPDU, or any other PPDU containing training symbols for sensing measurement, from the sensing transmitter.

The Measurement Report Control field of the Sensing Measurement Report may comprise a number of receive antennas (Nr) Index subfield. The Nr Index subfield may indicate a number of antennas, or index referring to a number of antennas, which may be used to receive a NDP PPDU, or any other PPDU containing training symbols for sensing measurement, at the sensing receiver.

The Measurement Report Control field of the Sensing Measurement Report may comprise a Dialog Token subfield. The Dialog Token subfield may be used to signal identity information about a Sensing Measurement (e.g. Measurement Setup and/or Measurement Instance) to identify a current Sensing Measurement Setup/Instance.

The Measurement Report Control field of the Sensing Measurement Report may comprise a Punctured Channel Information (Info) subfield. The Punctured Channel Information subfield may indicate a list of the punctured subchannels in a NDP PPDU, or any other PPDU containing training symbols for sensing measurement. This subfield may indicate partial bandwidth sensing where only certain subset of the subchannels indicated by a BW field may be used to compute the sensing result.

The Measurement Report Control field of the Sensing Measurement Report may comprise a bandwidth (BW) subfield. The BW subfield may indicate information about the bandwidth of a NDP PPDU, or any other PPDU with training symbols for sensing measurements.

In an embodiment, the Measurement Type Dependent Parameters subfield may carry signaling information that may be different for different types of measurement results. In an example, as shown in FIG. 8, for frequency domain measurement results (e.g. CSI), the Measurement Type Dependent Parameters subfield may comprise the following parameters: Coefficient Size (Nb), which may indicate a number of bits used in the representation of the real and imaginary parts of each element of the CSI; Subcarrier Grouping (Ng), which may indicate how many subcarriers are grouped together and the CSI of those grouped subcarriers may be averaged in one value per group in the measurement result; and Measurement Reference or Measurement Instance ID (MII), which may carry the measurement instance identification (ID) of the reference measurement in case of differential CSI. The Measurement Type Dependent Parameters subfield for a frequency domain measurement result (e.g. CSI) may comprise one or more of the above parameters and/or may comprise additional or alternative parameters.

In an example, as shown in FIG. 9, for time-domain measurement results (e.g. CIR), the Measurement Type Dependent Parameters subfield may comprise the following parameters: Coefficient Size (Nb), which may indicate a number of bits used in the representation of the real and imaginary parts of each element of the CIR, or any time-domain representation of the sensing measurement result; and Number of Values (Nvalues), which may indicate a number of complex values the measurement report carries in a punctured CIR (PCIR). The Measurement Type Dependent Parameters subfield for a time domain measurement result (e.g. CSI) may comprise one or more of the above parameters and/or may comprise additional or alternative parameters.

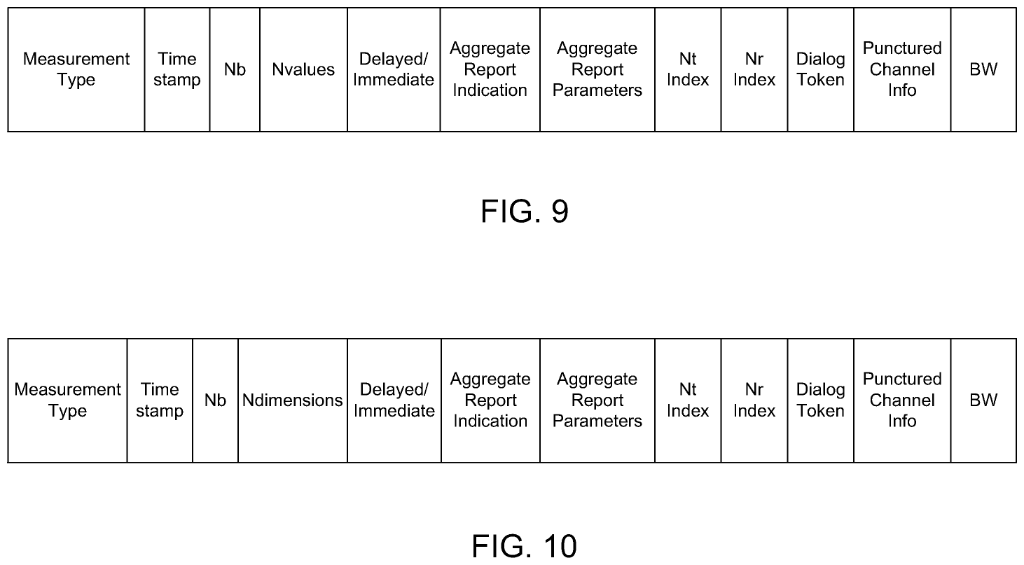

In an example, as shown in FIG. 10, for DMG/EDMG measurement results, the Measurement Type Dependent Parameters subfield may comprise the following parameters: Number of Dimensions (Ndimensions) of a Filtered MAP, which may be used to indicate a number of dimensions in the filtered map for radar applications (e.g., 2D, 3D, or 4D); and Coefficient Size (Nb), which may indicate a number of bits used in the representation of each element of the map (e.g., Range, Azimuth, Elevation, and Doppler). The Measurement Type Dependent Parameters subfield for a DMG/EDMG measurement result may comprise one or more of the above parameters and/or may comprise additional or alternative parameters.

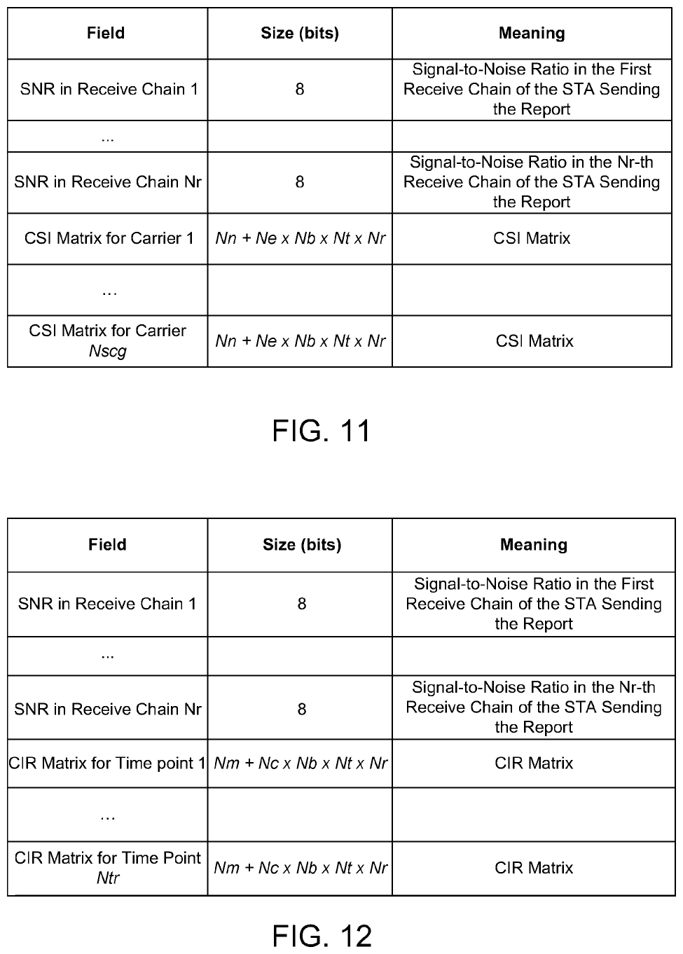

In an embodiment, a Measurement Report field may be designed to carry sensing measurement results of different types. The contents of the Measurement Report field may differ according to the type of measurement. In an example, the Measurement Report field for frequency-domain results may be designed as shown in FIG. 11.

In FIG. 11, Nscg=[Nsc/Ng] is the number of subcarrier groups for which the measurement is reported, Nsc is the number of subcarriers in the reported channel bandwidth, Ng is the subcarrier grouping, Nn is the number of bits used for representing the normalization coefficient of each CSI matrix, Ne is the number of elements in each coefficient of the CSI matrix taking the value Ne=1 if either the amplitude or phase is reported for each subcarrier group (e.g., in partial CSI) or the value Ne=2 if both real and imaginary parts of each coefficient are reported.

In an example, a normalization coefficient may be reported once for an entire report and not for each CSI matrix where it may be computed to be the largest value of all real and imaginary values of all CSI matrices of all subcarrier groups. In case of partial CSI, the normalization coefficient may be computed to be the largest amplitude in all CSI_AMPLITUDE of all subcarrier groups if only the amplitude is reported or the largest phase in all CSI_PHASE of all subcarrier groups if only the phase is reported.

In an embodiment, the Measurement Report design as shown in FIG. 11 may be used for differential CSI such that the reference measurement may be indicated in a Measurement Report Control field.

In an embodiment, the Measurement Report field for time-domain results may be designed as shown in FIG. 12. In this design, a matrix of size Nt×Nr for each time point may be reported where each value of the matrix may represent a CIR (e.g. power or amplitude) at this time point for a corresponding transmit antenna and receive antenna.

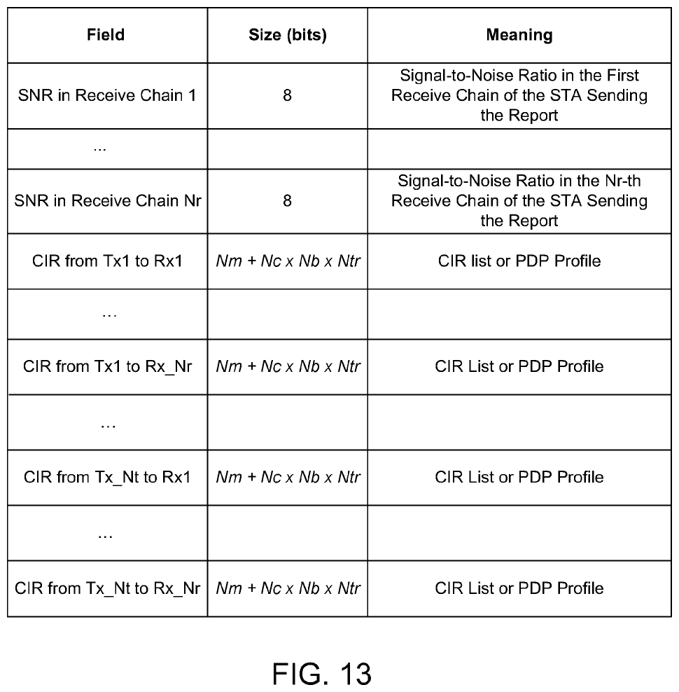

In an embodiment, the Measurement Report field for time-domain results may be designed as shown in FIG. 13. In this design, a list of CIR values or a PDP profile may be reported for all combinations from all transmit antennas to all receive antennas. In an example, a list of power values {p_0,p_1, . . . ,p_Ntr}, or amplitude values {h_0,h_1, . . . ,h_Ntr} may be reported for the channel between Tx Ant_x and Rx Ant_y with X∈{1, . . . , Nt} and y∈{1, . . . , Nr}.

In FIG. 13, Ntr is the number of CIR time points which may be a subset of the entire CIR (i.e., punctured CIR), Nm is the number of bits used for representing the normalization coefficient of each CIR matrix, Nc is the number of elements in each coefficient of the CIR matrix taking the value Nc=1 if only real value is reported for each time point or the value Nc=2 if both real and imaginary parts of each coefficient are reported.

In an embodiment, an RXVECTOR parameter SENSING_RESULT_CSI may be defined with a same design corresponding to the measurement type such that it may have the same format of the Measurement Report field in case of a CSI measurement type. In an embodiment, an RXVECTOR parameter SENSING_RESULT_CIR may be defined with the same design corresponding to the measurement type such that it may have the same format of the Measurement Report field in case of a CIR measurement type. In an embodiment, an RXVECTOR parameter SENSING_RESULT_DMG may be defined with the same design corresponding to the measurement type such that it may have the same format of the Measurement Report field in case of a DMG measurement type.

In CIR based feedback/reporting, a sensing receiver may obtain a set of samples, representing channel impulses at a set of time points {t₀, t₁, . . . , t_{N}}, tᵢ<tᵢ₊₁. This set of time points may be equally spaced, i.e., tᵢ₊₁−tᵢ=δt a constant, or unequally spaced, i.e., tᵢ₊₁−tᵢ=δtᵢ is a variable. The time t₀, may reference to a time point determined at a transmitter side (e.g., a boundary of a transmitted PPDU), or reference to a time point determined at a receiver side (e.g., a boundary of a received PPDU). In addition to the timing information of CIRs, the presentation of those pulses may be in the form of powers or magnitude, {p₀, p₁, . . . , P_{N}}, or a set of complex numbers generated from the channel estimation process {h₀, h₁, . . . , h_{N}}, corresponding to the set of times {t₀, t₁, . . . , t_{N}}. Therefore, the CIR may be presented in the form of {(t₀, p₀), (t₁, p₁), . . . , (t_{N}, p_{N})}, which may also be called power delay profile (PDP), or {(t₀, h₀), (t₁, h₁), . . . , (t_{N}, h_{N})}.

When generating and sending the CSI feedback based on CIR, the transmitter of the feedback may send a subset of CIR, i.e., {(tₖ_{₀}, hₖ_{₀}), (tₖ_{₁}, hₖ_{₁}), . . . , (tₖ_{_{M}}, hₖ_{_{M}})} or subset of PDP {(tₖ_{₀}, pₖ_{₀}), (tₖ_{₁}, Pₖ_{₁}), . . . (tₖ_{_{M}}, Pₖ_{_{M}})}, where M<N, {k₀, k₁, . . . , k_{M}}⊂{0, 1, . . . , N}. A method to select a subset may be based on the CIR feedback information, which may include, for example, one or more of the following: the sensing range in distance; the sensing distance, which may mean the distance between the target and sensing transmitter or the sensing receiver; sensing resolution in distance or in time; sensing signal bandwidth or the channel bandwidth that sensing signal is transmitted over; the significance of CIR power, which may be presented by a threshold p_{T}: when pᵢ>p_{T}, it will be fed back; the number of first CIRs or power points in the PDP; existence of Line of Sight (LOS); whether tₖ_{₀} is t₀ or not; if the selection of the subset of the CIRs are predefined with finite options, the index of the option.

Some or all of the CIR feedback information may be transmitted from the sensing transmitter to the sensing receiver in a frame (e.g., a NDP announcement frame or beacon frame). The sensing receiver may feedback the subset of CIRs based on a choice of some parameters in the CIR feedback information. Those parameters may be sent to the feedback receiver along with CIRs in the same feedback frame or a different frame that the feedback receiver may identify.

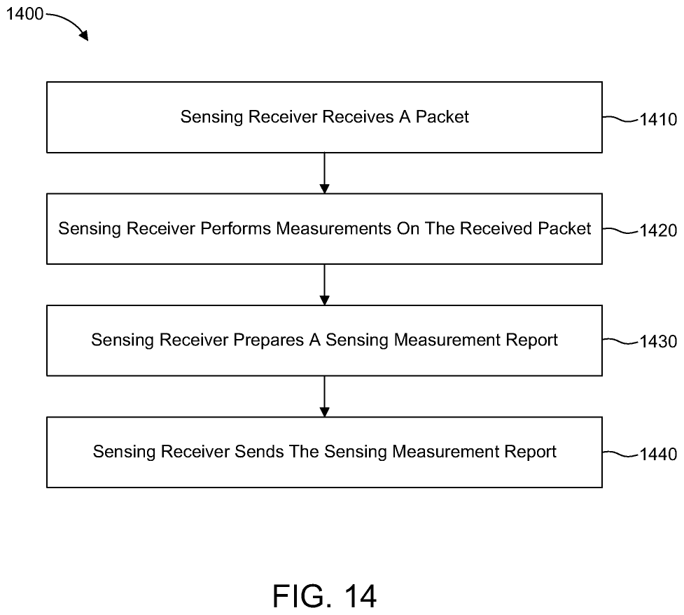

FIG. 14 shows an example procedure of WLAN sensing. A sensing receiver may receive, from a sensing transmitter, a packet (1410). The packet may be a NDP or PPDU. The packet may comprise training symbols. The sensing receiver may perform measurements on the receiver packet (1420). The sensing receiver may prepare a sensing measurement report (1430). The sensing measurement report may comprise a measurement report control field. The sensing measurement report may comprise a measurement report field. Parameters of a measurement type dependent parameter subfield of the measurement report control field may be based on a measurement type. The sensing receiver may send, to the sensing transmitter, the sensing measurement report (1440). Contents of the measurement report field may be based on the measurement type. The measurement report control field may comprise information for interpretation of sensing measurements included in the measurement report control field. The measurement type may comprise at least one of: a channel state information (CSI) type, a channel impulse response (CIR) type, and a directional multi-gigabit (DMG)/enhanced DMG (EDMG) type. The measurement type dependent parameters subfield for the CSI type may comprise at least one of: a coefficient size (Nb) parameter, a subcarrier grouping (Ng) parameter, and a measurement instance identification (MII) parameter. The measurement type dependent parameters subfield for a CIR type may comprise at least one of: a coefficient size parameter and a number of values parameter. The measurement type dependent parameters subfield for a DMG/EDMG type may comprise at least one of: a number of dimensions of a filtered MAP parameter and a coefficient size parameter. Parameters of the measurement type dependent parameters subfield may be used to parse the sensing measurement report.

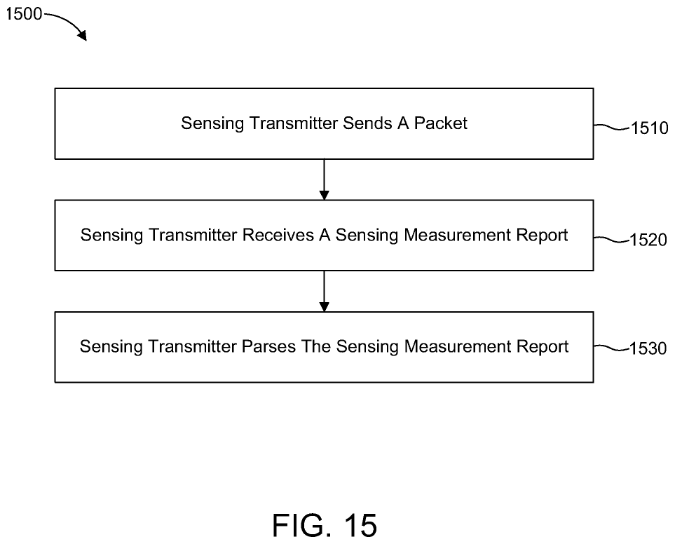

FIG. 15 shows an example procedure of WLAN sensing. A sensing transmitter may send, to a sensing receiver, a packet (1510). The packet may be a NDP or PPDU. The packet may comprise training symbols. The sensing transmitter may receive, from the sensing receiver, a sensing measurement report (1520). The sensing measurement report may comprise a measurement report control field. The sensing measurement report may comprise a measurement report field. Parameters of a measurement type dependent parameter subfield of the measurement report control field may be based on a measurement type. Contents of the measurement report field may be based on the measurement type. The measurement report control field may comprise information for interpretation of sensing measurements included in the measurement report control field. The measurement type may comprise at least one of: a channel state information (CSI) type, a channel impulse response (CIR) type, and a directional multi-gigabit (DMG)/enhanced DMG (EDMG) type. The measurement type dependent parameters subfield for the CSI type may comprise at least one of: a coefficient size (Nb) parameter, a subcarrier grouping (Ng) parameter, and a measurement instance identification (MII) parameter. The measurement type dependent parameters subfield for a CIR type may comprise at least one of: a coefficient size parameter and a number of values parameter. The measurement type dependent parameters subfield for a DMG/EDMG type may comprise at least one of: a number of dimensions of a filtered MAP parameter and a coefficient size parameter. The sensing transmitter may parse the sensing measurement report (1530). The sensing transmitter may parse the sensing measurement report based on parameters in the measurement type dependent parameters subfield of the measurement report control field.

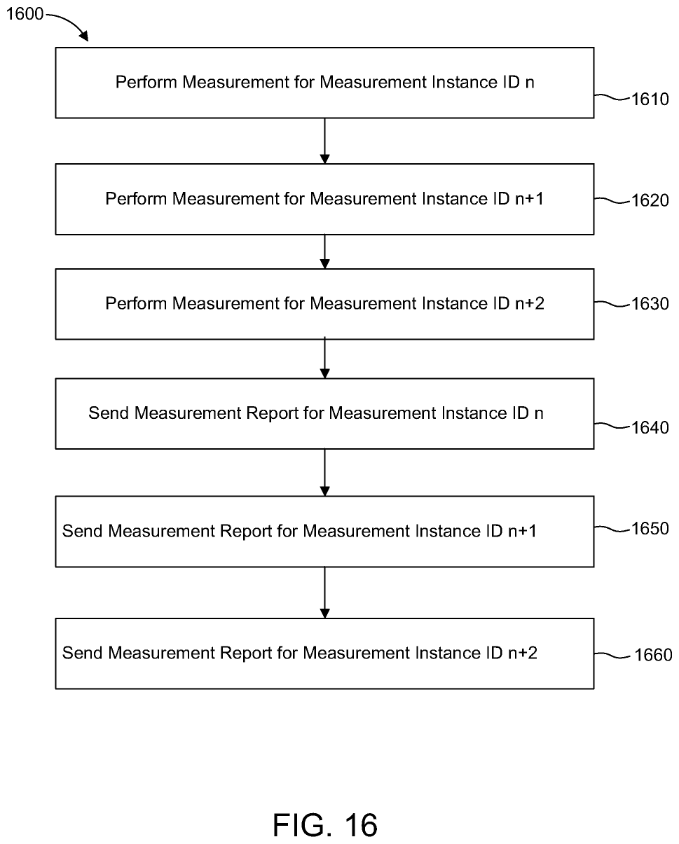

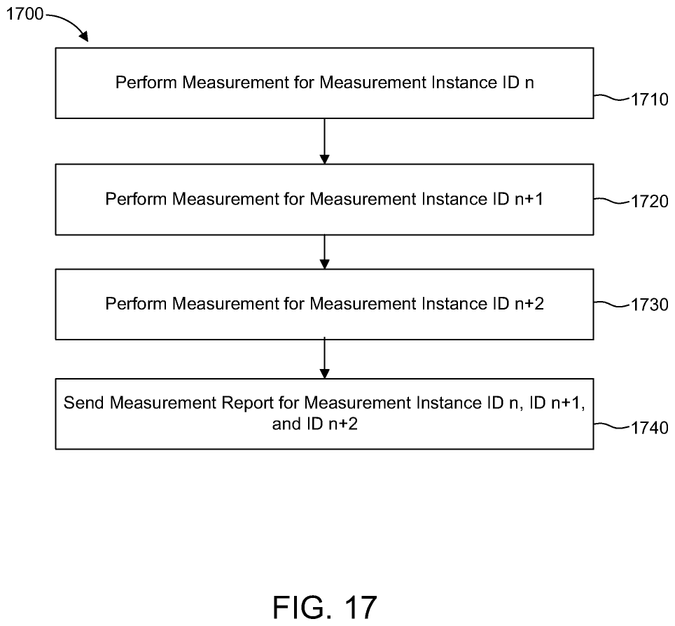

In an embodiment, methods that enable aggregation of multiple measurement reports are shown in FIG. 16 and FIG. 17. Multiple sensing reports may be delayed by at least one instance and may be carried in multiple PPDUs. For example, each measurement report may be carried in one PPDU and these PPDUs may be sent consecutively. In FIG. 16, an AP or STA may perform a measurement for measurement instance ID n (1610). The AP or STA may perform a measurement for measurement instance ID n+1 (1620). The AP or STA may perform a measurement for measurement instance ID n+2 (1630). The AP or STA may send a measurement report (e.g. in a PPDU) for measurement instance ID n (1640). The AP or STA may send a measurement report (e.g. in another PPDU) for measurement instance ID n+1 (1650). The AP or STA may send a measurement report (e.g. in another PPDU) for measurement instance ID n+2 (1660). Multiple sensing reports may be delayed by at least one instance and may be carried in one PPDU. In FIG. 17, an AP or STA may perform a measurement for measurement instance ID n (1710). The AP or STA may perform a measurement for measurement instance ID n+1 (1720). The AP or STA may perform a measurement for measurement instance ID n+2 (1730). The AP or STA may send a measurement report (e.g. in a PPDU) for measurement instance ID n, ID n+1, and ID n+2 (1740). The AP or STA may send the measurement instances ID n, ID n+1, and ID n+2 in a same PPDU. Three measurement instances (i.e. n, n+1, n+2) are shown in FIGS. 16 and 17 as an example and it is understood that there may be any number of measurement instances.

To support multiple sensing reports, parameters may be carried in a NDPA frame or a trigger frame sent by a sensing transmitter (e.g., an AP), or any control frame which starts a measurement setup.

An indication of delayed report parameter may be carried in a NDPA frame or trigger frame or any control frame which starts a measurement setup. This parameter may indicate if delayed sensing reports are allowed or not. For example, a value of 1 may represent that the delayed sensing report is allowed and a value of 0 may represent that the delayed sensing report is not allowed.

A maximum delayed time slots parameter may be carried in a NDPA frame or trigger frame or any control frame which starts a measurement setup. This parameter may indicate the maximum number of time slots which are allowed by the sensing transmitter or the sensing initiator to get the measurement reports. The number of time slots may be equal to the number of sensing instances or the number of NDPAs. For example, if the maximum delayed time slots is equal to 2, then it may mean that the sensing reports are to be sent by measurement instance ID=3 when the sensing NDPA (or the trigger sounding frame or other control frame) is transmitted in measurement instance ID=1.

A maximum number of measurement reports parameter may be carried in a NDPA frame or trigger frame or any control frame which starts measurement setup. This parameter may indicate the maximum number of measurement reports which may be reported in one PPDU or multiple consecutive PPDUs.

An indication of aggregation of sensing reports parameter may be carried in a NDPA frame or trigger frame or any control frame which starts a measurement setup. This parameter may indicate if the aggregation of sensing reports in one PPDU is allowed or not. For example, if the indication of aggregation of sensing report is 1, then multiple sensing reports may be allowed to be aggregated in one PPDU and if the indication of aggregation of sensing reports is 0, then only one sensing report may be allowed in one PPDU.

If a delay sensing report is not allowed, then the maximum delay time slots may be equal to 0, and the maximum number of measurement reports and the indication of aggregation of sensing reports may be reserved.

To ensure that multiple sensing reports may be sent consecutively without interruption, the sensing transmitter/initiator or the AP may reserve a transmission opportunity (TXOP) that may be used for a sensing measurement report. To notify the STAs that the reserved time allocated in a multi user (MU) request to send (RTS) transmission (TX) trigger frame (TF) is used for a sensing purpose, a bit in a multiuser trigger response scheduling (MU-TRS) trigger frame may be used to indicate the reserved time slot is used for sensing or not. For example, a value of 1 may represent that the time slot is reserved for sensing and a value of 0 may represent that the time slot is reserved for another purpose.

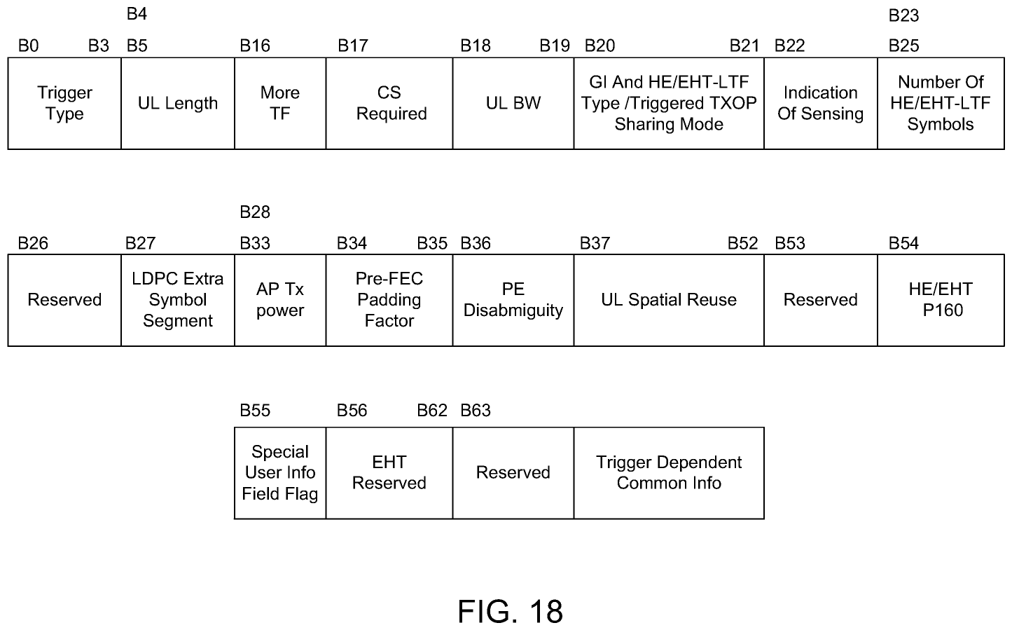

FIG. 18 shows an example enhanced EHT variant Common Info field format that may be used in a MU-RTS to reserve the following time slot for sensing. An Indication of Sensing subfield (B22) may indicate if the reserved time slot is used for sensing or not. Note that other reserved bits (e.g. B56-B62 or B63) or another bit in the trigger frame may be used to indicate the reserved time slot is used for sensing sounding and sensing report.

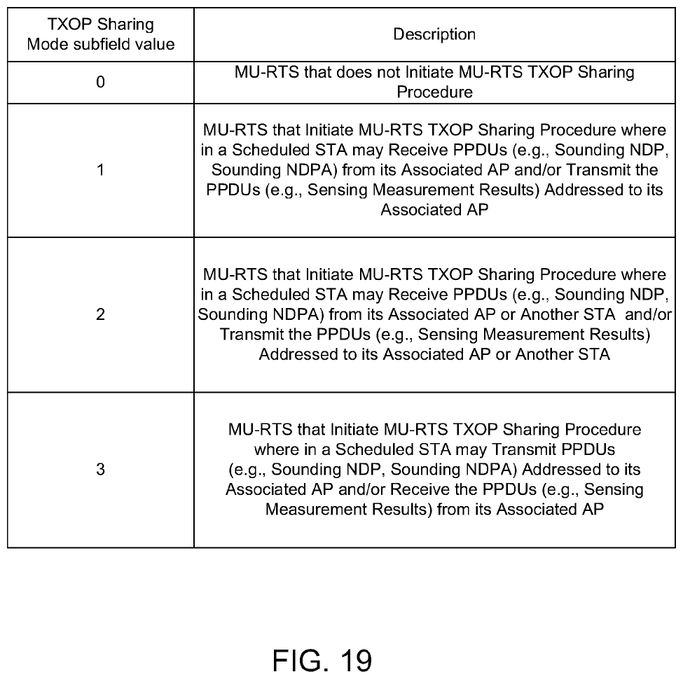

FIG. 19 shows an example encoding of a TXOP Sharing Mode subfield when an Enhance MU-RTS indicates the following time slot reserved for sensing only (e.g., Indication of Sensing subfield in MU-RTS common field is set to 1).

In an embodiment, in an exchange of an enhanced MU-RTS TXS Trigger frame with a TXOP Sharing Mode subfield value equal to 1, transmission of one or more sounding NDPA/NDP/Trigger frames may be sent from an AP to a scheduled STA and transmission of one or more measurement results from the scheduled STA to the AP may be sent. A NDPA/NDP/Trigger frame from the AP may be sent before the time allocated in a MU-RTS TX TF and the time allocated in a MU-RTS TX TF may be used for the collection of measurement results.

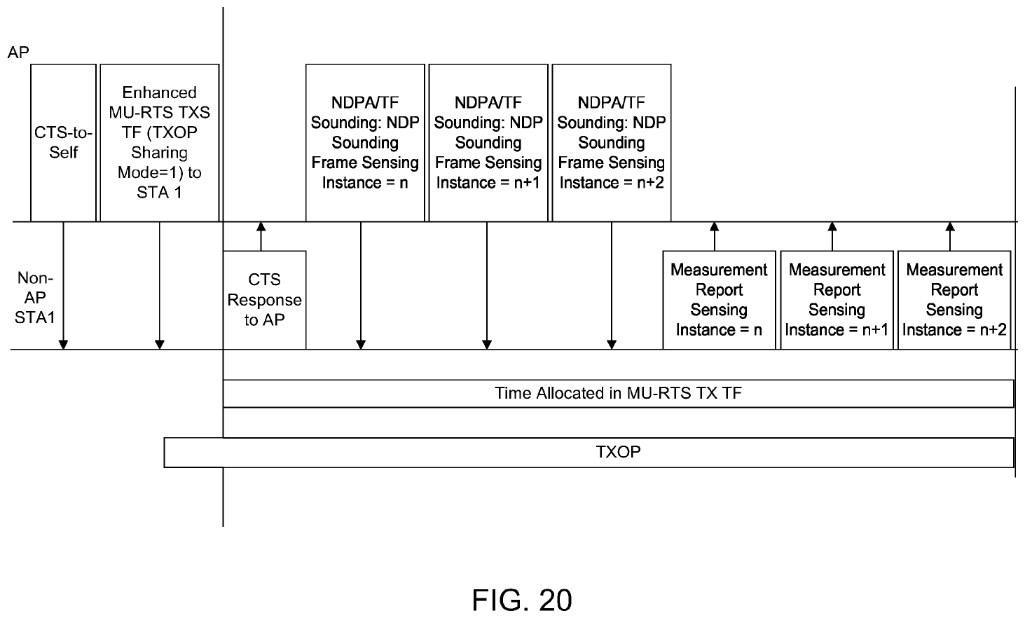

FIG. 20 shows an example exchange of an enhanced MU-RTS TXS Trigger frame with a TXOP Sharing Mode subfield value equal to 1. An AP may send a CTS-to-self to a non-AP STA (e.g. non-AP STA1). The AP may send an enhanced MU-RTS TXS TS, with TXOP Sharing Mode equal to 1, to STA1. STA1 may send a CTS response to the AP. The AP may send a NDPA/TF sounding frame, NDP Sound Frame Sensing Instance n, to STA1. The AP may send a NDPA/TF sounding frame, NDP Sound Frame Sensing Instance n+1, to STA1. The AP may send a NDPA/TF sounding frame, NDP Sound Frame Sensing Instance n+2, to STA1. STA1 may send a measurement report, sensing instance n, to the AP. STA1 may send a measurement report, sensing instance n+1 to the AP. STA1 may send a measurement report, sensing instance n+2, to the AP. In an embodiment, in an exchange of an enhanced MU-RTS TXS Trigger frame with TXOP Sharing Mode subfield value equal to 2, transmission of one or more sounding NDPA/NDP/Trigger frames may be sent from a scheduled STA to another STA and transmission of one or more measurement results may be sent from another STA to the scheduled STA. A NDPA/NDP/Trigger frame from the scheduled STA may be sent before the time allocated in MU-RTS TX TF and the time allocated in MU-RTS TX TF may be used for the collection of measurement results from another STA to the scheduled STA.

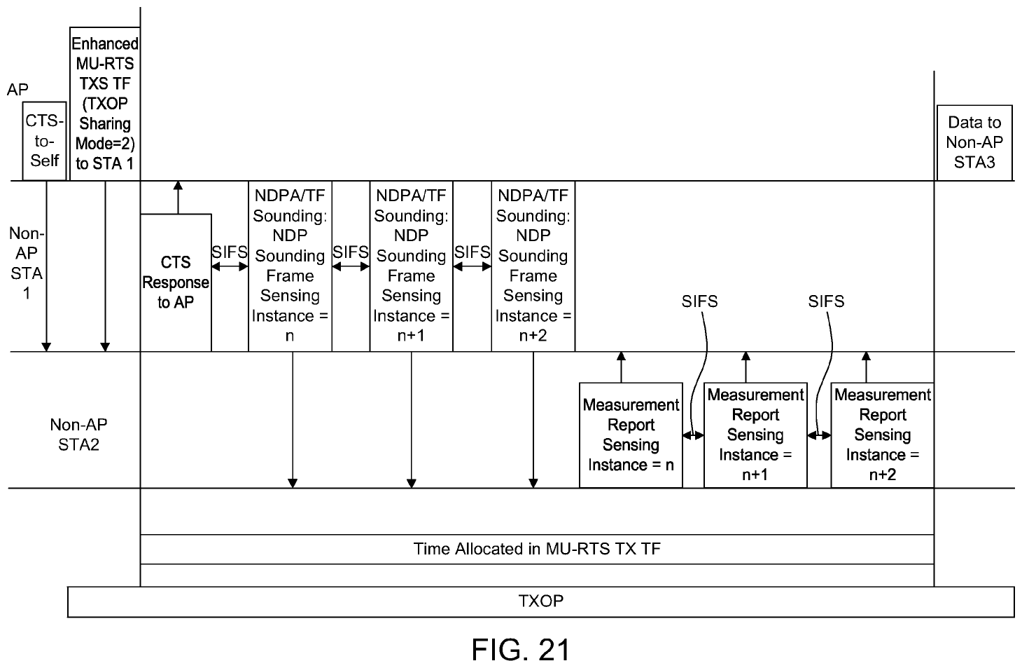

FIG. 21 shows an example exchange of an enhanced MU-RTS TXS Trigger frame with a TXOP Sharing Mode subfield value equal to 2. An AP may send a CTS-to-self to a non-AP STA (e.g. STA1). The AP may send an enhanced MU-RTS TXS TS, with TXOP Sharing Mode equal to 2, to STA1). STA1 may send a CTS response to the AP. STA1 may send a NDPA/TF sounding frame, NDP Sound Frame Sensing Instance n, to a second non-AP STA (e.g. STA2). The NDPA/TF sounding frame Sensing Instance n may be sent after a short interframe space (SIFS). STA1 may send a NDPA/TF sounding frame, NDP Sound Frame Sensing Instance n+1, to STA2. The NDPA/TF sounding frame Sensing Instance n+1 may be sent after a SIFS. STA1 may send a NDPA/TF sounding frame, NDP Sound Frame Sensing Instance n+2, to STA2. The NDPA/TF sounding frame Sensing Instance n+2 may be sent after a SIFS. STA2 may send a measurement report, sensing instance n, to STA1. STA22 may send a measurement report, sensing instance n+1 to STA21. STA22 may send a measurement report, sensing instance n+2, to STA1. The measurement reports for the sensing instances n, n+1, and n+2 may be send in separate transmissions (e.g. different PPDUs).

In an embodiment, in an exchange of an enhanced MU-RTS TXS Trigger frame with TXOP Sharing Mode subfield value equal to 3, transmission of one or more sounding NDPs may be sent from a scheduled STA to an AP and transmission of one or more measurement results may be sent from the AP to the scheduled STA. A NDP sounding frame from the scheduled STA to the AP may be sent before the time allocated in MU-RTS TX TF and the time allocated in MU-RTS TX TF may be used for the collection of measurement results from another STA to the scheduled STA. When the TXOP sharing subfield value is equal to three, it may also represent that another STA may transmit the NDPA or/and NDP sounding frame to the scheduled STA and the scheduled STA may send the sensing measurement result(s) to this STA. The reserved time slot may also be used for the collection of measurement results from the scheduled STA to another STA.

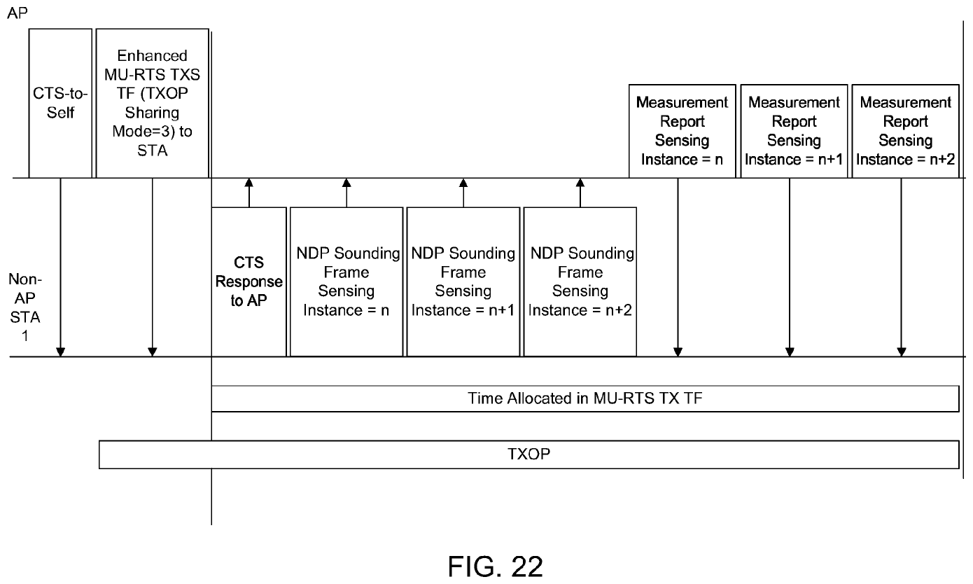

FIG. 22 shows an example exchange of an enhanced MU-RTS TXS Trigger frame with a TXOP Sharing Mode subfield value equal to 3. An AP may send a CTS-to-self to a non-AP STA (e.g. STA1). The AP may send an enhanced MU-RTS TXS TS, with TXOP Sharing Mode equal to 3, to a STA1. STA1 may send a CTS response to the AP. STA1 may send a NDPA/TF sounding frame, NDP Sound Frame Sensing Instance n, to the AP. STA1 may send a NDPA/TF sounding frame, NDP Sound Frame Sensing Instance n+1, to the AP. STA1 may send a NDPA/TF sounding frame, NDP Sound Frame Sensing Instance n+2, to the AP. The AP may send a measurement report, sensing instance n, to STA1. The AP may send a measurement report, sensing instance n+1 to STA1. The AP may send a measurement report, sensing instance n+2, to STA1. The measurement reports for the sensing instances n, n+1, and n+2 may be send in separate transmissions (e.g. different PPDUs).

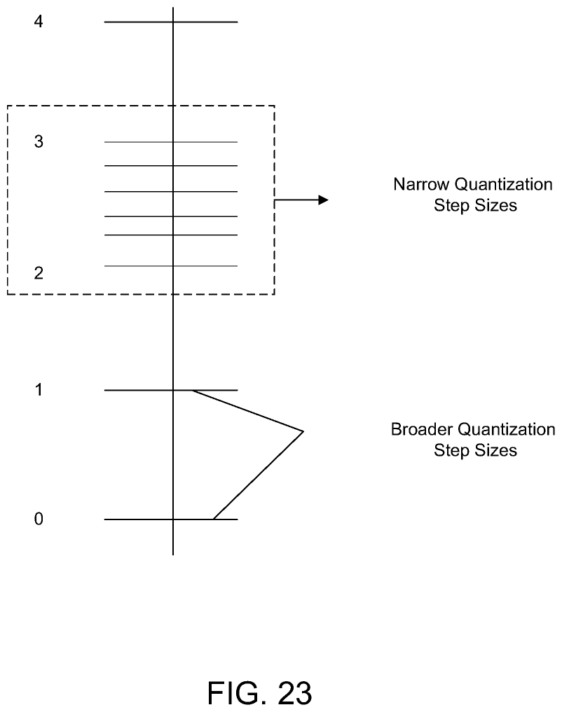

To improve the accuracy of sensing by minimizing a CSI/compressed CSI quantization error, non-uniform quantization may be used. Non-uniform quantization may help to provide the adapted step-sizes according to amplitude variations observed, as shown in FIG. 23. FIG. 23 shows an example of non-uniform quantization between CSI amplitude 0 and 4. Narrow quantization levels are used between interval 2 and interval 3. This feature improves the quantization distortion, thereby increasing the sensing accuracy. The non-uniform quantization-based step sizes may be different for different sensing applications. For example, to classify/monitor the activity of an individual/object, the CSI/compressed CSI variation over time may be observed. For a given activity, if the difference between the CSI values from a previous estimate (e.g. amplitude is 3.2), and the CSI values from a current estimate (e.g. amplitude is 3.4), is small (e.g. 0.2 in this example) then having a very narrow quantization level between 3 and the maximum variation for the specific sensing, i.e. (3, max variation), while keeping broader quantization levels for other amplitude variations, significantly improve the accuracy. More quantization levels may be allocated to more frequently seen amplitude values and the quantization step size may be reduced to amplitude values that are seldomly seen.

Different sensing applications may have different non-uniform quantization levels. Therefore, the type of the quantization a sensing receiver may use to feedback the quantized CSI/compressed CSI values to a sensing transmitter may be identified by the sensing feedback type indicated in a NDPA frame of the sensing transmitter. The sensing receiver, based on an initial amplitude value of the CSI, may use a narrow quantization step size from the observed initial amplitude. The initial observed CSI value may be indicated to the sensing transmitter so that the sensing transmitter may de-quantize CSI/compressed CSI values accordingly.

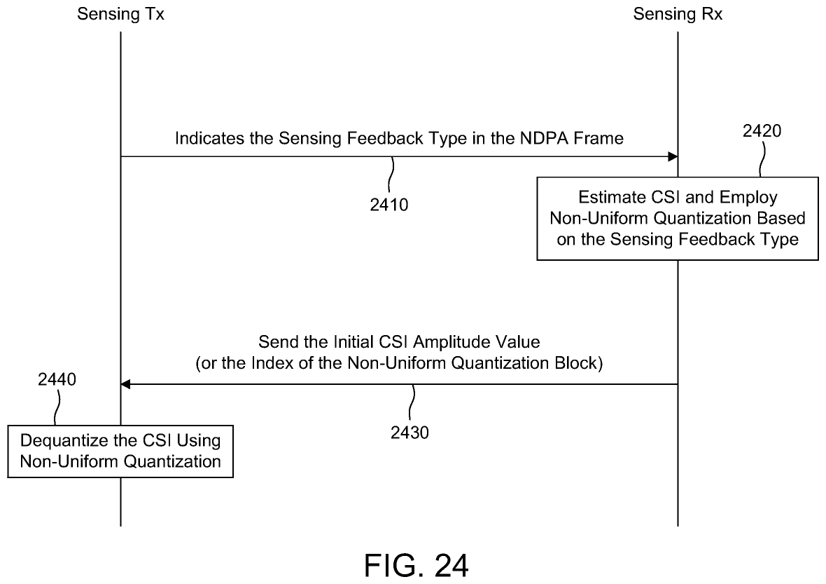

FIG. 24 shows a signaling procedure between a sensing transmitter (Tx) and a sensing receiver (Rx). The sensing Tx may indicate a sensing feedback type in a frame (e.g. null data packet announcement (NDPA) frame) and send the frame to the sensing Rx (2410). The sensing Rx may estimate CSI and use non-uniform quantization based on a sensing feedback type (2420). The sensing Rx may send the initial CSI amplitude value (or the index of the non-uniform quantization block) to the sensing Tx (2430). The sensing Tx may de-quantize the CSI using non-uniform quantization (2440).

In an embodiment, when multi-antennas are used in both a sensing transmitter and a sensing receiver, the sensing transmitter may use a null data packet announcement (NDPA) frame to indicate the sensing usage requirement of the transmitter antennas and receiver antennas for a sensing purpose. Alternatively, the sensing transmitter may indicate the sensing usage requirement of the transmitter antennas and receiver antennas in a Trigger frame.

To enable multi-antenna sensing, multiple elements which are related to transmit/receive antennas may be included the in the NDPA. In an embodiment, transmit/receive antenna information may be included in a field of an NDPA frame (e.g. a Common Info field of a NDPA frame).

Transmit (Tx) antenna indices may be included in the Common Info field of a NDPA frame. The Tx antenna indices may indicate the transmit antenna indices to STAs. It may comprise one or more bits and the number of bits may be equal to a maximum transmit antennas allowed by the device (e.g., 4 bits).

An indicator of multi-antenna sensing may be included in the Common Info field of a NDPA frame. The indicator of multi-antenna sensing may indicate if the sensing requires using multiple antennas or a single antenna. For example, it may comprise one bit: indicator of multi-antenna sensing=1 may represent that it requires all intended STAs to use multiple antennas to sense and/or feedback the results; indicator of multi-antenna sensing=0 may represent that it requires all intended STAs to use a single antenna to sense and/or feedback the results.

An indicator of receive (Rx) antenna index may be included in the Common Info field of a NDPA frame. The indicator of Rx antenna index may indicate if the receive antenna index needs to be included in the measurement reports. For example, it may comprise one bit: indicator of Rx antenna index=1 may indicate that it requires the recipient STA to indicate the Rx antenna index in the sensing measurement reports; and indicator of Rx antenna index=0 may indicate that it does not requires the recipient STA to indicate the Rx antenna index in the sensing measurement reports.

An indicator of the same Rx antenna(s) may be included in the Common Info field of a NDPA frame. The indicator of the same Rx antenna(s) may indicate if the Rx antenna used for sensing may be the same or not as the last time used for the sensing. For example, it may comprise one bit: indicator of the same Rx antenna(s)=1 may indicate that it requires the recipient STA to use the same Rx antenna as the last time used for sensing; and indicator of the same Rx antenna(s)=0 may indicate that it does not require the recipient STA to use the same Rx antenna as the last time used for sensing.

In an embodiment, Tx/Rx antenna information may be included in a field of an NDPA frame (e.g. a STA Info field of a NDPA frame)

An indication of Rx antenna index may be included in a STA Info field of a NDPA frame. This indication may indicate a requirement of a corresponding STA to include the Rx antenna indices in the sensing report. For example, it may comprise one bit: indication of Rx antenna index=1 may represent that it requires the STA to include the Rx antenna index in the sensing report; and indication of Rx antenna index=0 may represents that it does not require the STA to include the Rx antenna index in the sensing report.

Rx antenna indices may be included in a STA Info field of a NDPA frame. The Rx antenna indices may indicate the Rx antenna indices used for sensing. The number of bits may be varied, which may depend on the number of receiver antennas in the intended STA. A maximum number of bits may be, for example, 3 bits.

The above information subfield(s) proposed for the Common Info field and STA Info field may be included in any type of NDPA format, which may be one mode of a Ranging NDPA, and/or a new NDPA Frame using a Control Frame Extension subtype in a Frame Control Field and/or a new type of EHT/HE NDPA.

The above information may also be included in a Trigger frame when there is a Trigger Based (TB) measurement instance. In an embodiment, the Rx/Tx related information in the STA capability may include, but is not limited to, the following elements. The use of different Rx antennas to sense the channel may be included. The use of different Rx antenna to sense the channel may indicate if the STA may use different Rx antenna(s) to sense the channel. For example, it may comprise one bit: use different Rx antenna to sense the channel=1 may indicate that it is able to use different Rx antenna(s) to sense the channel for the same or a different application; and use different Rx antenna to sense the channel=0 may indicate that it is not able to use different antenna(s) to sense the channel for the same or a different application.

The use of different Tx antennas to transmit NDP may be included. The use of different Tx antennas to transmit NDP may indicate if the STA may use different Tx antenna(s) to transmit the NDP. For example, it may comprise one bit: use different Tx antennas to transmit the NDP=1 may indicate that it is able to use different Tx antenna(s) to transmit NDP for the same or a different application; and use different Tx antennas to transmit NDP=0 may indicate that it is not able to use different Tx antenna(s) to transmit the NDP for the same or a different application.

A maximum number of Rx antennas used for sensing may be included. The maximum number of Rx antennas used for sensing may indicate the maximum number of Rx antennas used for sensing.

The maximum number of Tx antennas used for transmitting NDP may be included. The maximum number of Tx antennas used for transmitting NDP may indicate the maximum number of Tx antennas used for transmitting NDP.

In an embodiment, an intended STA that receives Tx/Rx related information included in the NDPA frame or Trigger frame may include the Tx/Rx related information in the sensing measurement report.

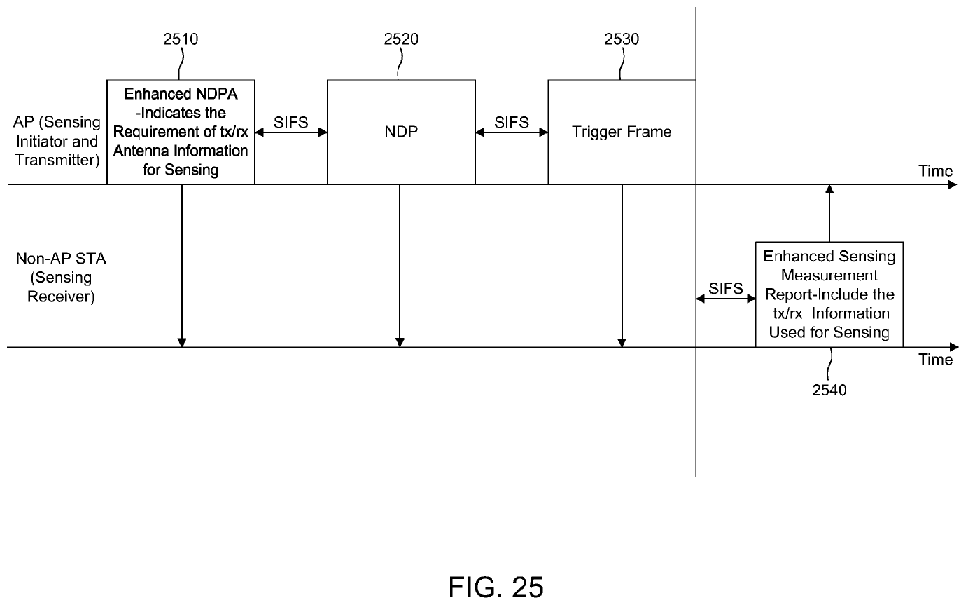

FIG. 25 shows an example procedure of multi-antenna sensing in a trigger based (TB) sensing measurement instance. In this case, the AP, which is the sensing initiator and sensing transmitter, may transmit an enhanced NDPA to a non-AP STA, which is the sensing receiver (2510). The enhanced NDPA may comprise sensing requirements related to Tx and Rx antennas. The enhanced NDPA may be sent after a short inter-frame space (SIFS). The AP may send an NDP to the non-AP STA (2520). The NDP may be sent after an SIFS. The AP may send a Trigger frame to the non-AP STA (2530). The trigger frame may be sent after an SIFS. Upon receipt of the Trigger frame, which may follow the NDP and enhanced NDPA, the non-AP STA may send an enhanced sensing measurement report to the AP (2540). The enhanced sensing measurement report may include the Tx/Rx information used for sensing. The enhanced sensing measurement report may be sent after an SIFS.

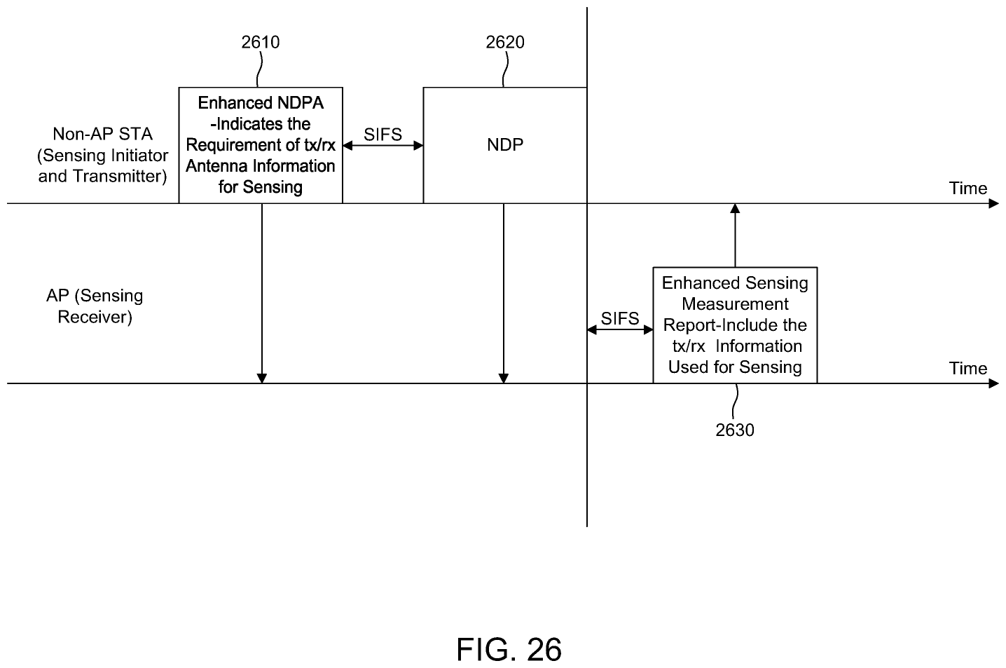

FIG. 26 shows an example procedure of multi-antenna sensing in a non-TB sensing measurement instance. In this case, the non-AP STA, which is the sensing initiator and sensing transmitter, may transmit an enhanced NDPA to an AP, which is the sensing receiver (2610). The enhanced NDPA may comprise sensing requirements related to Tx and Rx antennas. The enhanced NDPA may be sent after an SIFS. The non-AP STA may send an NDP to the AP (2620). The NDP may be sent after an SIFS. Upon receipt of a NDP, which may follow the enhanced NDPA, the AP may send an enhanced sensing measurement report to the non-AP STA (2630). The enhanced sensing measurement report may include the Tx/Rx information used for sensing. The enhanced sensing measurement report may be sent after an SIFS.

In an embodiment, an enhanced sensing measurement report may include, but is not limited to, the following information for multi-antenna sensing: (1) indices of receiver antennas used for sensing which may indicate which receiver antennas are used to sense the channel; (2) indices of transmit antennas used for sensing which may indicate which transmit antennas from the sensing transmitter are used for sensing the channel; (3) indices of transmit antennas used for sending a sensing measurement report which may indicate which transmit antennas from the sensing receiver are used for transmitting sensing results; (4) number of receiver antennas used for sensing which may indicate the number of receiver antennas used to sense the channel; (5) number of transmit antennas used for sensing which may indicate the number of transmit antennas used to sense the channel; (6) number of transmit antennas used for sending a sensing measurement report which may indicate the number of transmit antennas used to transmit the sensing measurement report.

The above information may be included in a MIMO control field of the enhanced sensing measurement report.

In an embodiment, a STA supporting a sensing operation may support preamble puncturing in which one or more subchannels of a BSS operating bandwidth may be announced as punctured subchannels (i.e. inactive subchannels) by an AP or non-AP STAs. The punctured subchannels may not be used for the transmission of a channel measurement PPDUs, such as NDP, a sounding announcement frame, such as a sensing NDPA or sensing sounding trigger frame variants, or a measurement report frame.

In an embodiment, STAs participating in a sensing session may determine the list of punctured subchannels by, for example, receiving and parsing an operation element that indicates the list of punctured subchannels. The indication of the punctured subchannels may include a bitmap or a lookup table indicating the list of the punctured subchannels. The operation element defining the list of punctured subchannels may be a predefined element in a previous generation, such as the EHT Operation element, or a newly defined operation element for a sensing operation.

In an embodiment, the sensing STAs may indicate whether they support optional sensing capabilities in a sensing capabilities element which may be broadcasted in a beacon frame, a (re)association frame, or any other management frame. A parameter of the sensing capabilities may be a punctured sensing support which may indicate the support of calculating sensing measurement results in a bandwidth with some of its subchannels punctured. This parameter may be, for example, set to one if the punctured sensing is implemented and may be set to zero otherwise.

In an embodiment, a sensing NDPA may include a sensing bandwidth information, or partial bandwidth information, subfield in a STA information field to indicate the punctured subchannels in the NDP which may follow (e.g. immediately follow) the NDPA after a short inter-frame space (SIFS). The punctured subchannel indication may be a bitmap or a lookup table and may cover all the BSS bandwidth. Each STA may determine the punctured subchannels in its operating bandwidth by determining the BSS operating bandwidth and decoding the punctured subchannel list. The STA operating bandwidth may be smaller than or larger than the BSS operating bandwidth. If the operating bandwidth of the STA is smaller than the BSS operating bandwidth, the AP may use the sensing bandwidth information, or partial bandwidth information, subfield to indicate the requested subchannels for sensing feedback measurements which may be a subset or all the subchannels which are within the operating bandwidth of the STA. If the operating bandwidth of the STA is larger than the BSS operating bandwidth, the AP may use the sensing bandwidth information, or partial bandwidth information, subfield to indicate the punctured subchannels in the BSS operating bandwidth which maps to a part of the bandwidth of the STA participating in the sensing session. The STA participating in the sensing measurement instance may send sensing measurements for the subchannels that are requested and are not punctured.

In an embodiment, the sensing NDPA may include a special STA information field which may be identified with a special STA identification (ID) and may be used to indicate the punctured subchannels for the STAs included in the sensing measurement instance. The special STA information field may include a subfield which may indicate a list of punctured subchannels in the operating bandwidth of the BSS. The list of punctured subchannels may be indicated in a common information field in an NDPA.

In an embodiment, the punctured channels in the NDPA may be indicated by the bandwidth of the NDPA and the requested subchannels for sensing indicated by the sensing bandwidth information, or partial bandwidth information, subfield.

In an embodiment, a SIG field(s) of an NDP (or any other PPDU with training symbols which may be used for sensing/channel measurements) may be used to indicate a bitmap or a lookup table of the punctured subchannels in a transmitted NDP. The list of punctured subchannels indicated in the NDP may be the same as the list of punctured subchannels indicated in the NDPA. In an embodiment, the AP may indicate additional punctured subchannels other than those indicated in the NDPA.

In an embodiment, a list of punctured subchannels may be indicated in a subfield (e.g. a punctured channel information subfield) of a common information field of a sensing trigger frame variant used by an AP for soliciting NDP (or any other PPDU with training symbols which may be used for sensing/channel measurements) transmissions from non-AP STAs. The triggered STAs may send the NDP covering the non-punctured subchannels. In an embodiment, the list of punctured subchannels may be indicated in a subfield (e.g. punctured channel information subfield) of a user information field. The triggered non-AP STAs may transmit the NDP and may indicate the list of punctured subchannels in a SIG field(s) of the solicited NDP. The triggered non-AP STAs may indicate additional punctured subchannels other than those indicated in the sensing trigger frame variant.

In an embodiment, an AP may indicate the punctured subchannels in a subfield (e.g. punctured channel information subfield) in a common information field of a sensing reporting trigger frame variant which may be used to trigger the sensing measurement reports from the STAs participating in the sensing measurement instance. In an embodiment, the AP may indicate the punctured subchannels in a subfield in a user information field. The triggered STAs participating in the sensing measurement instance may respond with a sensing measurement frame which may include the sensing measurements for the requested subchannels indicated in the sensing NDPA. The triggered STAs may indicate the list of the punctured subchannels in a subfield in the measurement report control field (e.g. punctured channel information subfield). The triggered STAs may puncture additional subchannels other than those indicated in the punctured channel information subfield of the sensing reporting trigger frame variant.

In an embodiment, a non-AP STA may send an NDPA to start a non-TB sensing measurement instance with an AP. The non-AP STA may indicate additional punctured subchannels other than those punctured subchannels indicated by the operation elements sent by the AP to the non-AP STAs. The non-AP may use a sensing bandwidth information, or partial bandwidth information, subfield of a STA information field to indicate the additionally punctured subchannels. In an embodiment, the additionally punctured subchannels may be indicated in a common field of the NDPA sent by the non-AP STA to start the non-TB sensing measure instance.

In an embodiment a non-AP STA may use a SIG field(s) of an Initiator-to-Responder (I2R) NDP of a non-TB sensing measurement instance to indicate the additionally punctured subchannels. In an embodiment, the AP may puncture additional subchannels other than those indicated in the NDPA and I2R and may use the Responder-to-Initiator (R2I) SIG field(s) to indicate the additionally punctured subchannels. The AP may indicate the punctured subchannels in a sensing measurement report control field of a sensing measurement report frame carrying the sensing measurement results of the non-TB sensing measurement instance.

In an embodiment, the setting of a threshold in threshold-based sensing may depend on the operating parameters for which this threshold is determined. One of the parameters may be the effective sensing bandwidth which may be defined as the sensing bandwidth excluding the punctured subchannels. The effective sensing bandwidth may change if the sensing bandwidth changes and/or the punctured subchannels list changes. The threshold may be renegotiated when the punctured channel list changes. The AP may dynamically puncture additional subchannels and when this occurs, the AP may reset the threshold to a new value.

Although the solutions described herein consider 802.11 specific protocols, it is understood that the solutions described herein are not restricted to this scenario and are applicable to other wireless systems.

Although SIFS is used to indicate various inter frame spacing in the examples of the designs and procedures, all other inter frame spacing such as RIFS, AIFS, DIFS or other agreed time intervals may be applied in the same solutions.

Although four RBs per triggered TXOP are shown in some figures as example, the actual number of RBs/channels/bandwidth utilized may vary.

Although specific bits are used to signal in-BSS/OBSS as example, other bits may be used to signal this information.

Although some Trigger Type values are used as examples to identify the newly defined trigger frame variants, other values may be used.

Multi-AP and MAP are used interchangeably to refer to the same concept.

Long Training Field (LTF) may be any type of predefined sequences that are known at both transmitter and receiver sides.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1.-20. (canceled)

21. A method of a non-access point (AP) station (STA) comprising:
receiving, from an AP, a message comprising information indicating punctured subchannels;
sending, to the AP, an indication that the non-AP STA supports punctured sensing;
negotiating, with the AP, sensing parameters;
performing a sensing session;
determining that the punctured subchannels has changed; and
renegotiating, with the AP, the sensing parameters, in response to the determining that the punctured subchannels has changed, wherein the renegotiated sensing parameters comprise setting a threshold for threshold-based sensing.

22. The method of claim 21, wherein a punctured subchannel is a disabled subchannel or an inactive subchannel.

23. The method of claim 21, wherein the information indicating punctured subchannels comprises a list of the punctured subchannels, a lookup table indicating the punctured subchannels, or a bitmap of the punctured subchannels.

24. The method of claim 21, wherein the indication that the non-AP STA supports punctured sensing is sent in a punctured sensing support field of a sensing capabilities element.

25. The method of claim 21, wherein the indication that the non-AP STA supports punctured sensing indicates support of determining sensing measurement results in a bandwidth with some of its subchannels punctured.

26. The method of claim 21, wherein the determining that the punctured subchannels has changed comprises adding additional punctured subchannels.

27. The method of claim 21, wherein the punctured subchannels have changed since a last sensing session.

28. The method of claim 21, wherein the punctured subchannels are from a basic service set (BSS) operating bandwidth.

29. The method of claim 21, wherein the message comprising information indicating punctured subchannels is an EHT operation information element.

30. The method of claim 21, wherein the indication that the non-AP STA supports punctured sensing is sent in a beacon frame, a reassociation frame, or a management frame.

31. A non-access point (AP) station (STA) comprising:
a receiver configured to receive, from an AP, a message comprising information indicating punctured subchannels;
a transmitter configured to send, to the AP, an indication that the non-AP STA supports punctured sensing;
a processor, the transmitter, and the receiver configured to negotiate, with the AP, sensing parameters;
the processor, the transmitter, and the receiver configured to perform a sensing session;
the processor configured to determine that the punctured subchannels has changed; and
the processor, the transmitter, and the receiver configured to renegotiate, with the AP, the sensing parameters, in response to the determining that the punctured subchannels has changed, wherein the renegotiated sensing parameters comprise setting a threshold for threshold-based sensing.

32. The non-AP STA of claim 31, wherein a punctured subchannel is a disabled subchannel or an inactive subchannel.

33. The non-AP STA of claim 31, wherein the information indicating punctured subchannels comprises a list of the punctured subchannels, a lookup table indicating the punctured subchannels, or a bitmap of the punctured subchannels.

34. The non-AP STA of claim 31, wherein the indication that the non-AP STA supports punctured sensing is sent in a punctured sensing support field of a sensing capabilities element.

35. The non-AP STA of claim 31, wherein the indication that the non-AP STA supports punctured sensing indicates support of determining sensing measurement results in a bandwidth with some of its subchannels punctured.

36. The non-AP STA of claim 31, wherein the determining that the punctured subchannels has changed comprises adding additional punctured subchannels.

37. The non-AP STA of claim 31, wherein the punctured subchannels have changed since a last sensing session.

38. The non-AP STA of claim 31, wherein the punctured subchannels are from a basic service set (BSS) operating bandwidth.

39. The non-AP STA of claim 31, wherein the message comprising information indicating punctured subchannels is an EHT operation information element.

40. The non-AP STA of claim 31, wherein the indication that the non-AP STA supports punctured sensing is sent in a beacon frame, a reassociation frame, or a management frame.
